(19) United States
(12) Patent Application Publication
(10) Pub. No.: US 2002/0129382 A1
(43) Pub. Date: Sep. 12, 2002

(54) Adaptive method for browsing internet videotex data on-line by using the sdtv

(76) Inventors: Kun Zhao, Beijing (CN); Du Julong, Beijing (CN)

Correspondence Address: Fish & Richardson, 225 Franlin Street, Boston, MA, 02110-2804, US

(21) Appl. No.: 10/009,150

(22) PCT Filed: Dec. 29, 2000
(86) PCT No.: PCT/CN00/00746

(30) Foreign Application Priority Data
Mar. 31, 2000 (CN) 00105579.8

(51) Int. Cl. H04N 7/08

(52) U.S. Cl. 725/137

(57) ABSTRACT

The invention discloses a method that can acquire high quality display effect when a high-resolution is showed on a low-resolution display (e.g. SDTV) using digital image processing technology at client-end. Meanwhile any part of the original image can also be arbitrarily zoomed to display high-resolution images on SDTV with different display ratio. When the original image can not be entirely displayed on the screen of SDTV due to zooming, the rest of the original image can be browsed by changing the relative position of visible screen area on the original image. So it is more convenient for the user to surf and browse on-tine by SDTV.

### TECHNICAL FIELD

The present invention relates to a digital image processing method. It is an image processing method to display high-resolution images on low-resolution display devices. To be more specific, it is an adaptive image processing method on client-end device to process high-resolution images, such as contents from Internet web pages, to be suitable for display on low-resolution display devices, such as Standard Definition Television (SDTV) receiver.

### BACKGROUND TECHNOLOGY

Recently, with the rapid development of the Internet, it not only has deeper impact on every area of the economy, but also significantly changes our daily life. Therefore, the number of Internet users is developing at high speed around the world. In pace with the popularization and developing of Internet, the methods of accessing to the Internet and browsing web pages are getting more and more varieties. For instance, Internet contents can be surfed and browsed on-line with a computer via a modem or via a set box connected to a SDTV set set. As is well known, most of Web pages are designed to display on a VGA or SVGA standard computer monitor, which requires 800×600 or 1024×768 pixels resolution for the browsing monitor. Most of currently used computer monitors can meet this requirement. Therefore, a clear, original, and colorful Web page can be seen by a computer user on-line. However, if Web pages are browsed via a set-top box (or a similar device) connected to a SDTV set, following problems may occur:

(1) Since a SDTV set has only about 500×500 pixels resolution, massive pixels are lost during displaying the high-resolution images from the Internet using a SDTV set.

(2) Since progressive scanning standard is adopted by a computer monitor, while interlaced scanning technology is employed by the standard television, thus flickering phenomena occurs during browsing the high-resolution Internet contents using a standard television.

(3) Since the bandwidth of receivable video signal for the SDTV set is narrower than that for the computer monitor, bandwidth of the images designed for the computer monitor is broader than the permissible bandwidth for the standard television. When the images are showed on the standard television, the frequency aliasing will seriously distort the display quality.

The above-mentioned is why the display quality is descended when we browse web pages via a SDTV set. Several technologies are developed to improve the quality of displaying Web pages on SDTV set, but none of them can show the Web pages without changing their original design.

One of the technologies is to display the whole Web pages on the SDTV screen in a certain scale. As a result, when the Web pages is not especially designed for adapting to displaying on the television, the images have a poor viewing quality with distortion such as blurring, color offset, flickering and so on. Another technology adopted by some company, such as webTV™, is to reorganize the Web pages on server end so that they are suitable for displaying on the type of low-resolution monitor, e.g. a television. Then the reorganized content is downloaded to the user on-line using a television. This method achieved the purpose of viewing the Web page content clearly. However, the viewer can only see the Web page content, and the Web page structure is rebuilt, which completely lose the individual style, layout and artistry pursued by the original Web page designer.

The object of the invention is to provide a method to solve the above problems while using a SDTV to browse the Internet contents, i.e. to provide an adaptive method (WebScope method) to browsing Web pages using lower resolution display equipment such as SDTV at client-end. This method enables a user to browse Internet via SDTV or other similar lower solution monitor to see a clear Web page content under the premise of not damaging the individual style, layout and artistry originally pursued by the Web page designer.

### DISCLOSURE OF THE INVENTION

The invention provides a display adaptive method of performing digital image processing for the high resolution image signal coming from the Internet Web pages, enabling it to adapt to showing on a low-resolution display such as a SDTV set and the alike.

Furthermore, by means of the invented method, an original high-resolution image can be fully or partly zoomed arbitrarily. Meanwhile any local section of the original image can be arbitrarily browsed, enabling it to be more convenient for the user employing a low-resolution display equipment, such as a SDTV, to browse and surf on-line.

The method proposed by the invention is characterized in showing a higher resolution image in different display ratio on SDTV by zooming original image. When the original image cannot be fully shown on a SDTV screen due to zooming, the rest of the original image can be browsed by changing the relative position of visible screen area on the original image.

Preferably said method comprises the following steps: set an viewing reference point; set a zoom scale; carry out zooming for image data of viewing area determined by the said viewing reference point and zoom scale via digital filtering; reshape the bandwidth of video signal.

### BRIEF DESCRIPTION OF DRAWINGS

Further features, objects and advantages will be evident from the following detailed description of the preferred embodiments of the present invention taken in conjunction with the accompanying drawings in which;

FIG. 1 is an example of an original Web page coming from the Internet to be shown on the SDTV set according to the display adaptive method of the invention;

FIG. 2 indicates of the effect when the Web page image shown in FIG. 1 is displayed on a SDTV set;

FIG. 3 illustrates the effects when the user is interested to the circled area in FIG. 2, by moving a cursor to the concerned area, meanwhile transforming the zoom scale for the original image, the effect is observable on the television screen according to the display adaptive method of the invention;

FIG. 4 illustrates the effects which is the visual effect showing on the television by changing the image zoom scale once again based on the display adaptive method of the invention when the user is dissatisfied with the display effect as shown on FIG. 3 acquired after processing the original image data according to the user's instruction for WebScope.

FIG. 5 indicates a schematic, according to the display adaptive method of the invention, when display effect meets the user's requirement, if the user wants to see other parts of the whole Web page, he can browse any portion of the whole Web page on the television by moving a cursor to change the viewing reference point; FIG. 5 indicates a schematic based on the situation shown in FIG. 4 after dragging a cursor towards upper right direction;

FIG. 6 indicates a schematic of a situation to be observed after dragging towards lower left direction by the user based on the situation shown in FIG. 4 according to the display adaptive method of the invention;

FIG. 7 explains a hardware environment of a preferred embodiment according to the display adaptive method of he invention;

FIG. 8 explains a flow chart of a preferred embodiment realizing the display adaptive method of the invention according to the hardware environment of FIG. 7;

FIG. 9 explains a flow chart of interrupting the serving program in the user interface for realizing the preferred embodiment of display adaptive method in the invention under the hardware environment according to FIG.7;

FIG. 10 explains a schematic realizing image enlargement utilizing the increasing sampling point method;

FIG. 11 is a process schematic realizing re-sampling with a sampling rate converter, applying the interpolation principle to the display adaptive method of the invention.

### DESCRIPTION OF THE PREFERRED EMBODIMENTS

The embodiment of the present invention will be described in detail hereinafter with reference to the accompanying drawings, in which the like reference numerals refer to the parts and the equivalents.

First referring to FIGS. 1-6, an explanation on how the display adaptive method of the invention carries out digital image processing to the videotex information coming from the Internet by the display adaptive method to acquire good display effect on a lower resolution display device such as a SDTV set.

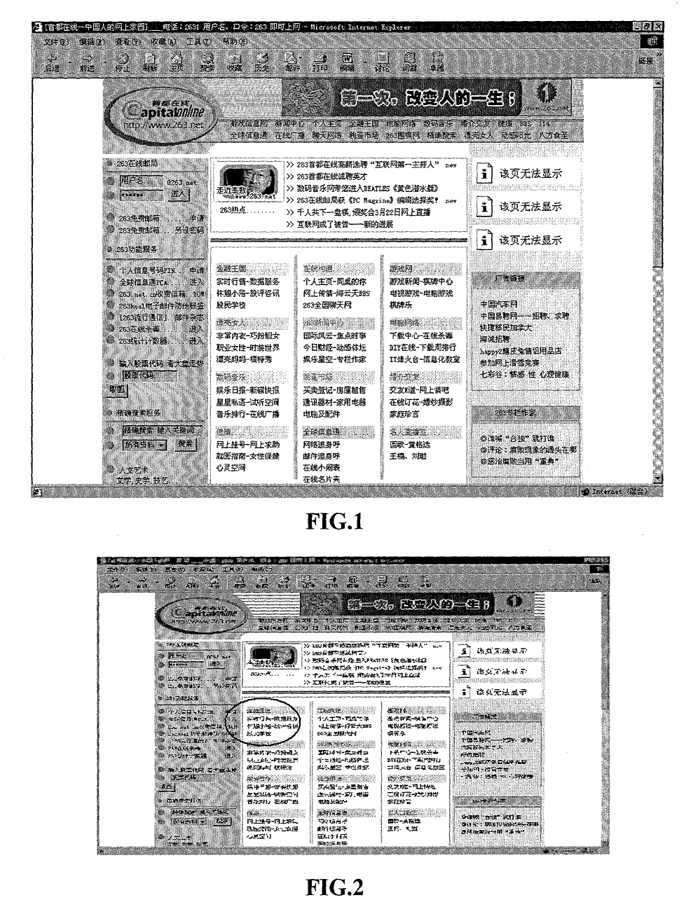

As shown in FIG. 1, this is an example of a certain Web page we hope to see on the television. It is an image of 1024×768 points. If an image like it is directly displayed on the television entirely, we can see an display effect as shown in FIG. 2. Practically FIG. 2 is the effect fully shown on the television screen after the original image is reduced proportionally. Obviously, we can not see clearly the image from FIG. 2, though at this time a normal user can still see an approximate structure of the whole Web page and the approximate situation of information. Under the situation, massive detailed information of the image displayed on the television shall be lost, i.e. network videotex information is obscure if it is browsed by SDTV directly. The circle in FIG. 2 is a position symbol added on the schematic, to indicate the area to be discussed that the user hope to be clearly seen, which will be described in detail as follows.

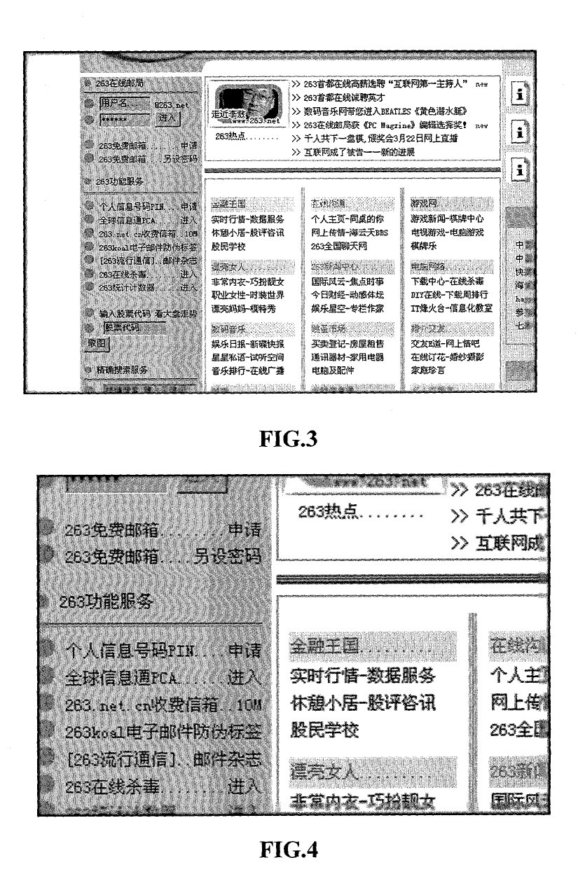

At this time, if the user is interested to a certain local of the information, e.g. to the circled area in FIG. 2, the user can move a cursor to the area and change zoom scale of the original image by the display adaptive method of the invention via a outside interface device. Thus the effect as shown on FIG. 3 processed by the invention is displayed on the television. Though we only see a local image, the content of the local image can be clearly displayed on the television screen. If the displayed effect is still unsatisfactory, then the user can continue to adjust the zoom scale by the interface device, until a satisfactory effect is achieved.

As for the user employing a television on line, the content can be seen on the television screen forms the observed area, which may be a whole or local Web page. Determination of the observed area depends on the cursor, i.e. the position of viewing reference point, and the current zoom scale. When the zoom scale varies, the size of visual area depends on the zoom scale. Generally, the current cursor position is a central position of the area (if the computed area passed over the range of original image, then image area needed to processed should be redefined according to the boundary of original image). When the cursor is moving single alone, the size of observed area shall be invariant. In fact, the image area need to be processed is invariant before the current cursor position moves out of the visible viewing reference point. In contrast with the area processed at last time, if the present cursor position moves out of the old processed area, the new boundary of processed area shall be re-defined so that the cursor just can be surrounded.

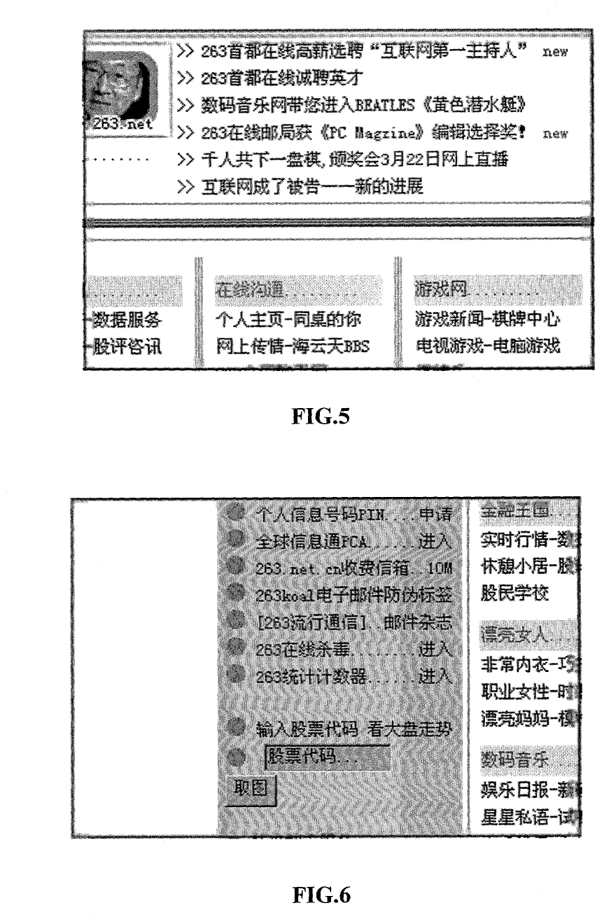

As shown in FIG. 4 is a schematic of enlarged effect. After the local section had been enlarged, the user can only see a certain local section of the original Web page image. If the user hope to see the information of other area, other sections can be browsed by the method of moving cursor position to change the relative position of viewing reference point in original Web page image. As shown in FIGS. 5, 6, these represent the situation seen by the user respectively in that shown in FIG. 4 where the user pulls over the cursor position for a certain distance towards upper right or lower left direction. As for the display adaptive method, the original image can be enlarged or contracted at any ratio according to the user's instructions to attain the display effect satisfied for the user. Meanwhile, this is also a man-machine interactive process, while the processing method is to analyze the user controlled information transferred via a man-machine interactive interface device, and process the section of image hope to be viewed by the user according to the user controlled information.

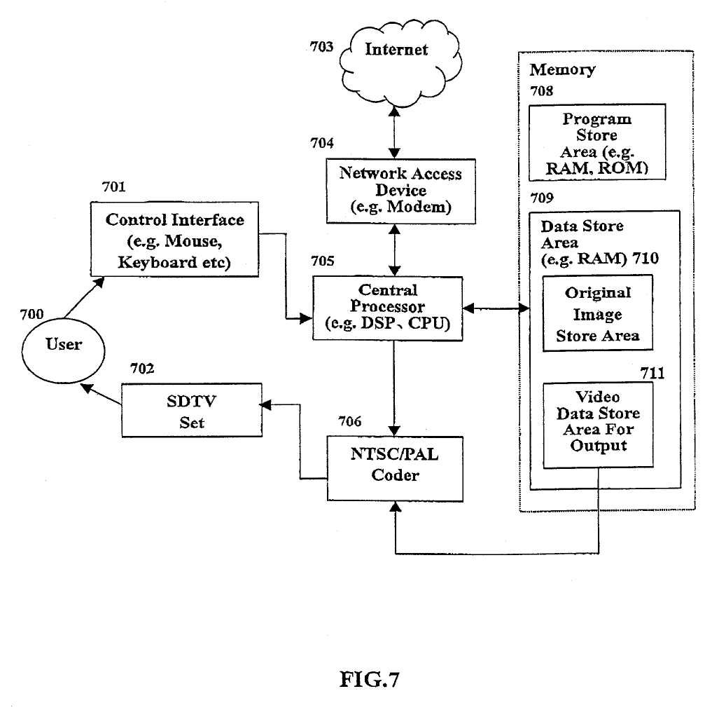

Next refer to the specific embodiment generating the effect as shown in FIGS. 1-6 by the display adaptive method of the invention described in FIGS. 7-9. Referring to FIG. 7, symbol 701 represents the user interface controlled by the user. Symbol 702 represents the SDTV set. Symbol 703 represents the Internet. Symbol 704 represents the network access devices such as modem etc. Symbol 705 represents the central processors such as DSP, CPU etc. Symbol 706 represents a NTSC/PAL coder or other devices of such a like. Symbol 707 represents a memory. Symbol 708 represents a store area storing Web Browser software program, coded program according to the display adaptive method of the invention and other program of user interface software modules such as RAM, ROM etc. Symbol 709 represents data store area such as RAM etc. Symbol 710 represents the store area of original videotex data. Symbol 711 represents the store area of videotex data output.

Every specific requirement for implementing the display adaptive method of the invention is described as follows:

Acquirement of the control commend information needed for the display adaptive method of the invention:

These are the functions of the so called man-machine interface unit. In practice, man-machine interface functions may be provided by the system-level equipment driving unit, i.e. any instruction input device realizing dialogue between the user and the central processor 705.

On the details of these interface devices driving, coding of all the corresponding equipment driver can be determined according to the situation in specific implementation. For instance, if a mouse is chosen for a control interface device, the only thing needed to do is to record the variation status of the mouse by changing some memory, e.g. registers etc., thereby attain the object of acquiring control information. Meanwhile in practical implement, the type of devices such as a keyboard, a remote controller, a joy stick etc. can serve as the equipment for receiving the user controlled information. For example: we may define the “+” and “−” keys in the keyboard to control the variation of zoom scale (e.g. “+” represent the increase of enlargement ratio, “−” represent the increase of contraction ratio); Similarly a common remote controller can also be utilized (e.g. the remote controller configured by a set box). Some of its keys may be redefined to control the cursor and the variation of zoom scale, as for how to define specifically, it is just required to achieve the aim of convenient to use, and of simple to realization. This is a problem considered in product manufacturing for easy operability of the product and whether the user interface is friendly or not, that is no direct relation with the spirit of the invention, therefore it is not necessary to discussion. Using which type of interface device is not limited, the only requirement is to receive and record the control command of the user in moving the cursor position varying the zoom scale so that can realize the instruction input of the dialogue between the user and the central processor. For the point, any average technician of this art scope is able to realize the aim by selecting relevant interface devices based on their characteristics.

Acquisition of data to be processed:

This is realized via WebBrowser. WebBrowser is stored in the memory with the form of software module. The function of a browser is performed via calling the program by the central processor. Previously we have mentioned what the invention want to solve is how to use a low-resolution display device such as a common standard television to browse the network videotex information on-line. As for acquisition of network videotex information, which is the problem concerned by WebBrowser. The method for videotex information processing is started from acquired Web page data, i.e. it is not started until the WebBrowser acquires the Web page data that the user want to see and transforms them into the image data for display.

Image processing for the acquired data:

The process is performed by central processor 705 according to control command issued by the user via calling the coded program based on the display adaptive method of the invention stored in the program memory 708. Its specific realization process shall be described in detail hereafter.

Generation of code modulation of television signal:

Final generated result of the invention is the data of digital video image data could be displayed on the television after code modulation. And the generated digital video image data are only required to meet the rule of CCIR601. Output digital video data according to the output format defined by CCIR656 standard, then the data can match with the digital video coder compatible with CCIR656 standard (e.g. SAA7185 of PHILIPS or other chips of such a like, the only requirement is compatible with CCIR656 standard). After going through the digital video coder, then the analog video signal receivable by the television can be acquired. After such a transform, the user can see the video image signal acquired by processing method proposed by the invention. As for the specific technical details of digital video coder, we can obtain easily some information about the interface characteristic and typical design circuit etc. by reading the data instruction of the chip.

The embodiment said here is only a specific example for the display adaptive method of the invention. Something above-mentioned is the environment (comprising hardware and software environment) to realize the display adaptive method of the invention. Should be emphasized is that the method of the invention does not rely upon a special hardware or software environment. The only requirement is to provide three outside condition, e.g. the acquirement of the control command information, the acquirement of the network videotex data and the generation of the television signal code modulation.

Meanwhile, should be noticed is that, on the aspect of quiring Web page data, the invention is not require to use a specific WebBrowser. The popular IE™ of Microsoft Co. or Netscape™ of Netscape Co. or any other kind of WebBrowser are all be allowed, which can be determined by the person or company using the invention. Concerning the interface problems of these WebBrowser, the corresponding technical data can be acquired from the intellectual right owner after purchasing license. Some source codes of the WebBrowser has public download address, e.g. Netscape Co. provided public download service for source code of Netscape™ on its home page (http://www.netscape.com). If those technicians are interested to the process of how to acquire network information on-line and transform it into image data for display, they can download the source code by themselves.

The specific embodiment of display adaptive method mentioned by the invention may be described according to FIGS. 7-9 as follows:

Refer to FIG. 7, it gives a schematic of the specific environment of implementation of display adaptive method, wherein Internet 730 is connected to network access device 704 via a communication line, user interface 701, NTSC/PAL coder 706 and memory 707 are connected to central processor 705 respectively, NTSC/PAL coder 706 is connected to SDTV set 702. After acquiring videotex data using the tools like the WebBrowser etc., the user can selective set the area he want to see using the user interface 701. the area may be the totality of the image, may also be a local of the image, i.e. zoom setting may be performed. The said user interface for setting may be a mouse, such as InteliMouse™, which has two keys and a roller. the roller can be defined as a control “focus”, i.e. a device of zoom scale. Those killed in the art understand that, besides using the above mouse, any instruction input device for realizing dialogue between the user and central processor 705 can be also used.

Central processor 705 accepts the user control instructions to implement digital filtering for the videotex data in the set area in set zoom scale by calling the relevant programs such as coded programs based on the display adaptive method of the invention stored in the memory 707 (the said digital filtering and related operation shall be further described here in after). The videotex data having a appropriate zoom scale suited for displaying on the SDTV set is placed into the output video image data store area 711 of the memory 707, finally output into the SDTV set 702 via NTSC/PAL coder 706.

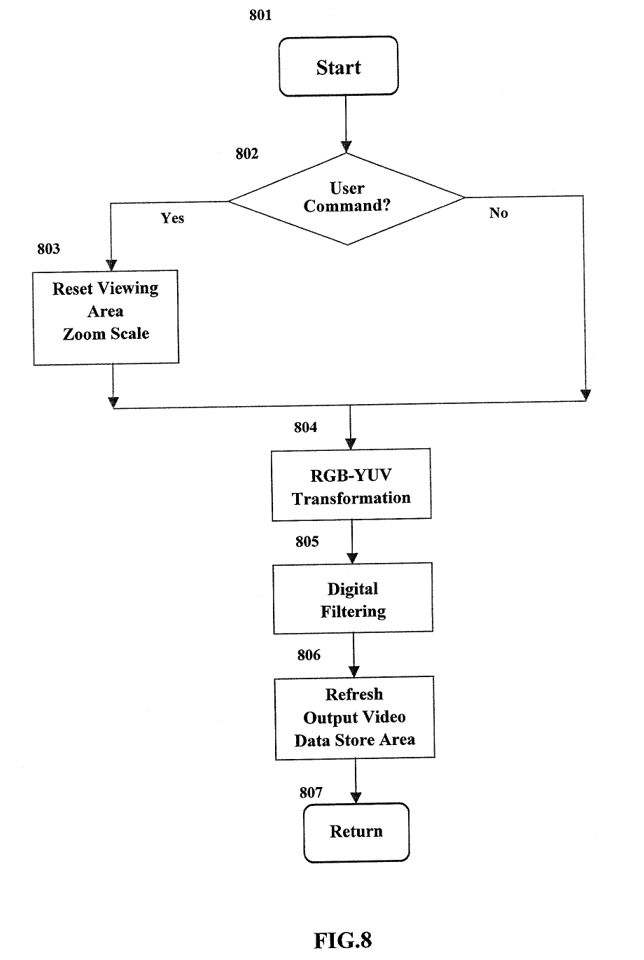

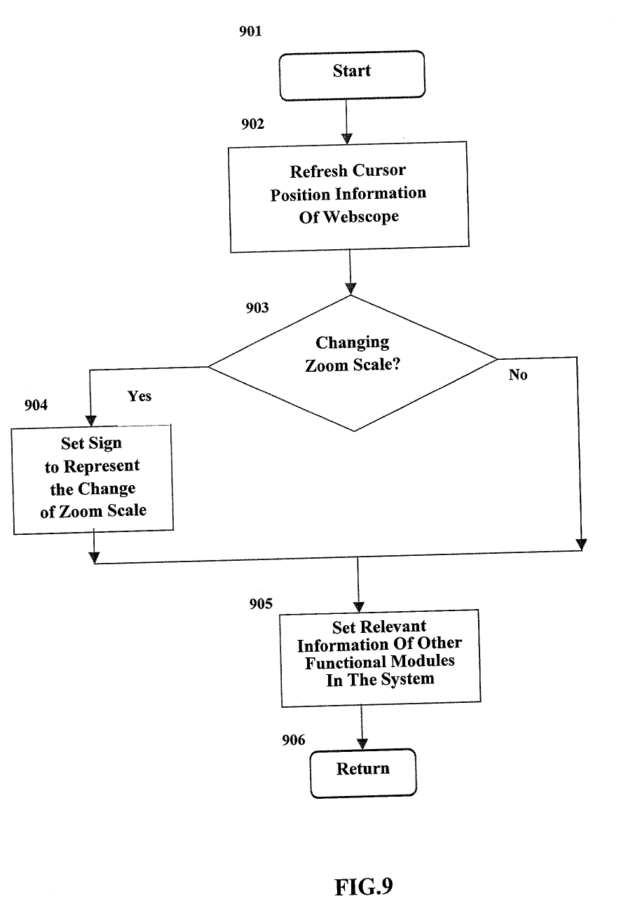

Next, referring to FIG. 8, it is a flow chart of the preferred embodiment for explaining the display adaptive method of the invention under the hardware environment according to FIG. 7. The flow chart represents a process that the central processor 705 calls coded program based on the display adaptive method from the program store area 708 by the central processor 705.

Step 801 is start. The image was showed on the television screen. The user inputs a control command, such as image enlargement, via the control interface 701 like a keyboard or mouse etc.

On step 802, at this time the central processor 705 acquires the user command information in the control interface 701, and then detect the user command. If the detected result shows that the cursor position or the zoom scale of original image is transformed, or both are varied, then in step 803, the central processor 705 resets the viewing reference point and zoom scale according to the user's instructions. For instance, according to the users instruction of enlarging image, central processor 705 sets the image enlargement ratio to be doubled. Then proceed to step 804. If the detecting result of step 802 is “no”, then still adopt the previously set window and zoom scale, directly go forward to step 804.

Step 804 is to carry out transformation from RGB to YUV. Here the transformation from RGB to YUV can also be conducted following step 805. The central processor 705 calls the data acquired from step 803 or the original data to carry out transformation from RGB to YUV so that the video signal can be suitable for display on standard television. The reason of adding this step is most WebBrowsers are designed for application on a computer so that most generated image data belong to RGB system (should be mentioned here is, when WebScope is implemented specifically, if the selected browser can provide the output of videotex data of YUV system, then this step may be omitted. Here we consider that the common situation is generated image data belong to the RGB system).

Then the flow progresses to step 805 to digital filtering. Actually, the function of this filtering is to zoom image data of the area and restrict the video signal bandwidth to a acceptable range for the standard television before code modulation, and eliminate the flicker phenomena due to interlace scanning, and filter out the excessive high frequency components generating interference, and form the video signal matching with SDTV set bandwidth. For instance to satisfy the video signal bandwidth restriction for 4.2 MHz of NTSC system or 6 MHz of PAL system. In fact, from the view of the principle of Digital Signal Processing, in terms of Digital Signal Processing, the zooming process for digital image is the process of resampling and generating new digital image based on new sampling rate.

Next the relationship between image's enlargement or contraction and sample processing of the invention shall be specifically described. Corresponding to image's enlargement or contraction, the resampling is the process of increasing or reducing sample points for the original image. Since the distance between the two fluorescent points on the display device keeps invariant, therefore after increasing/reducing the sample points of the original image, the effect displayed on the same screen is the enlargement/contraction of original image.

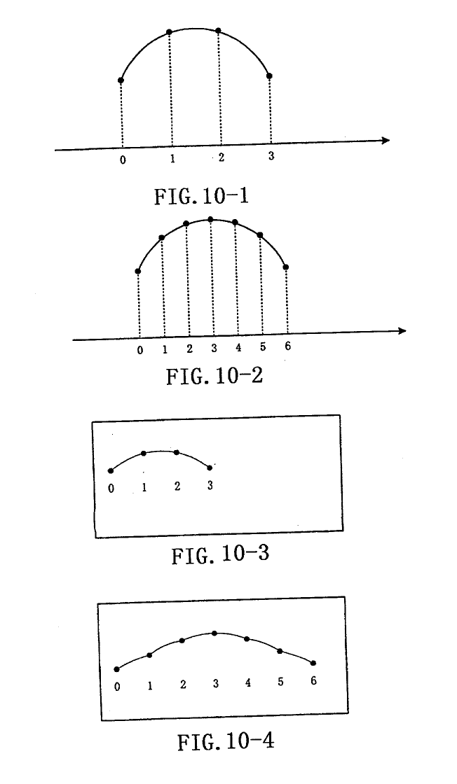

There are many methods to increase or reduce the sample points, e.g. linear interpolation, least square method etc. Referring to FIG. 10, let's take a curve for example to describe how the original image is enlarged by increasing sample points. As shown on FIG. 10-1, if the original sample points for the image is the four sample points of 0, 1, 2, 3, then the image displayed on the screen is the effect as shown on FIG. 10-3. Now if we increase the sample points i.e. interpolate new sample points between the two original sampling points according to a certain rule (e.g. linear interpolation), we can get seven sample points of 0, 1, 2, 3, 4, 5, 6 as shown in FIG. 10-2. If we resample based on the number of sample points interpolated and display them on a same screen, then we can see the image shown on FIG. 10-4. Therefore, we can enlarge the image by increasing sample points and raising the sampling rate. If want to contract the image, we just need to perform a inverse process of the above process i.e. reducing the sample points.

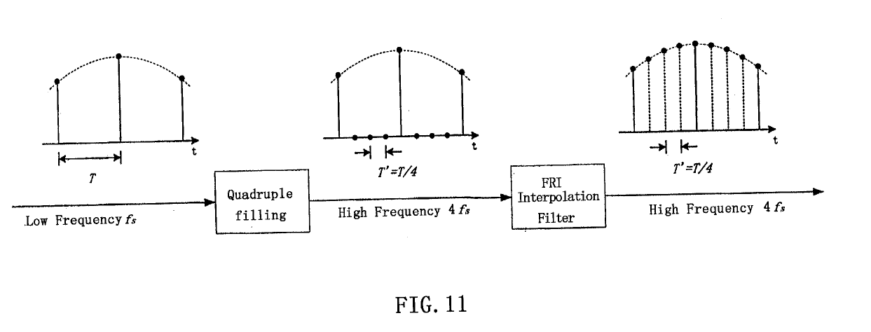

In the specific embodiment, the invention practices the principle of zooming image via a digital filtering module. In the terms of digital signal processing to describe the characteristic of the digital filtering module, it is just a sampling rate converter. Taking quadruple interpolation sampling as an example, as shown on the FIG. 11, the sampling rate converter is operated according to the following principle: i.e. on the time domain three sample points valued at 0 are interpolated between every two low rate sample points so that the data length is prolonged by four times of original data length. And then a new sequence can be acquired after the temporal generated sequence pass through a digital lowpass filter. At this time the “O” point in original sequence is replaced by a new number computed by the filter, thereby, the conversion of sampling rate is preformed. Frequency characteristic of digital filtering for the sampling rate converter is that of a lowpass filter, which can restrict bandwidth of digital video signal simultaneously.

The details of the sampling rate converter can refer to Sophales J. Orlanidis, “Introduction to Signal Processing”, Prentice-Hall Co., 1996, pp.704-711. In this reference, detailed description for realization and characteristic of the sampling rate converter is provided. Furthermore, discussion on a digital filter (FIR type digital filter) can refer to pp.541-568 in the book.

The details of digital filtering are thoroughly described on the books of the fundamentals of digital signal processing (e.g. A. V Oppenbeim, R W Schafer Trenticer, “Digital Signal Processing”, Prentice Hall, Englewood Cliffs, N.J., 1975, and L. R. Rabiner, B. Gold, “Theory and Application of Digital Signal Processing”, Prentice Hall, Englewood Cliffs, N.J., 1975, etc.). Digital filtering is a matured technology, therefore discussion of its frequency characteristic should not be described further.

The solution to interline flicker problem occurring by using standard television to display high-resolution image shall be described as follows. The standard television utilizes the persistence of vision of human eyes, which overcomes the phenomena of large area flicker by the interlace scanning mode of dividing an image into two fields to transmit. Here the brightness of the whole screen is repeated based on field. For instance, there is 50 fields/s in PAL system, which is just higher than critical flicker frequency (48 Hz). But the brightness of every line is repeated based on frame, i.e. 25 frames/s, which is lower than critical flicker frequency. Thus when brighter details emerged, interline flicker may be generated. To solve this problem, the embodiment resample for the original image. For the data process in horizontal director, the cutoff frequency of the Sampling Rate Converter (SRC) meets the requirement of signal bandwidth of television system. For the data process in vertical direction, the SRC also plays the role of lowpass to restrict the variety of whole image in vertical direction. A television image frame generated by the method has less difference between odd and even lines, which solves the flicker phenomena of SDTV caused by the interlace scanning.

The realization of digital filtering function of step 805 is a process that the central processor 705 calls the display adaptive program from the program store area 708. The central processor 705 calls the display adaptive program in the program store area and determines the parameters, e.g. increase or decrease of sample points etc, according to the zoom scale set by step 803. For instance, when the user inputs an instruction of doubling the image via a mouse, the display adaptive program implements resampling process and changes parameters to double the sample points according to the doubling instruction.

After display adaptive program had been implemented, the central processor 705 stores the new acquired data in the data store area 711.

Then the flow process proceeds to step 806. After refreshing the data buffer area of output video signal, a frame of YUV image is completed. The central processor 705 notifies the NTSC/PAL coder 706 that the video data has already been prepared. After output image data, flow process proceeds to step 807, i.e. return.

Here should be mentioned is that, the interface devices for changing the cursor's position and the zoom scale controlled by the user can be a mouse with a roller. Here, we defined the roller as means of controlling zoom scale. e.g pushing upward represents multiple increase and pushing downward represents multiple contraction. The current zoom scale should be determined according to previous zoom scale and the present roller action. Something should be reaffirmed is, although in the example a mouse with a roller is used for the interface device for accepting user control information, it does not imply that we must use the interface device like it. Just as above mentioned, there are no special requirements on specific realization of the invention for interface device, and the only requirement is that can achieve the object of receiving and storing the control command issued by the user.

Next, referring to FIG. 9, it explains a flow chart of a interrupt service routine of the user interface device in the preferred embodiment of display adaptive method of the invention, according to the environment of FIG. 7. The flow chart starts from step 901. Step 902 is refreshing cursor position information needed by the display adaptive method. Then proceed to step 903 to detect the control command information of changing the zoom scale. If detected result is “YES”, then proceed to step 904 and set the sign to represent the change of the zoom scale. And then proceeds to step 905 and set the relevant information of other functional modules in the system. If the detected result of step 903 is “NO”, then proceed to step 905 directly and set relevant information of other functional modules in the system. Then the flow chart proceeds to step 906 i.e. returns.

### INDUSTRIAL APPLICABILITY

The invention solved the said problems of prior art during browsing videotex information on-line using SDTV, i.e. the adaptive method (WebScope method) of browsing videotex data on-line using a low-resolution display device like SDTV etc. at client-end. The method enables the users to browse clearly the network information using SDTV (or other low-resolution monitors of such a like) under the premise of not harming the individual style, layout and artistic effect pursued by the Web page designer, and to see easily the original real network world.

Although the invention had been described incorporating the preferred embodiments, those skilled in the art, under the premise of not departing from the fundamental spirit and scope of the invention, can perform many various modifications or changes. Therefore protection range of the invention is restricted by the following attached claims.

Some of the terms mentioned in the text are added “TM” symbols, showing they are trademarks. Their ownership belongs to the company registered the trademarks.

1. A display adaptive method of browsing videotex information on-line, displaying the high-resolution image generated by the Internet Web page using the low-resolution display device at client-end, and high quality display effect is guaranteed,
wherein, by zooming the original image, high-resolution image is displayed with different display ratio on SDTV in high display quality, when the original image cannot be fully displayed on the screen of display device due to zooming, the rest of the original image can be browsed by changing the relative position of visible screen area on the original image.

2. A display adaptive method according to claim 1,
wherein, it may be realized via the following steps:
Acquire said original videotex data having high-resolution;
Set an viewing reference point and a zoom scale;
Carry out digital filtering for the designated videotex data according to the said viewing reference point and zoom scale;
Display the zoomed image according to the said zoom scale and viewing reference point:

3. A display adaptive method according to claim 1,
wherein, said low-resolution display device is a standard television.

4. A display adaptive method according to claim 2,
wherein, said setting of viewing reference point and zoom scale are realized by input control instructions via an input device.

5. A display adaptive method according to claim 4,
wherein, said input device is a keyboard or a mouse.

6. A display adaptive method according to claim 2,
wherein, said digital filtering process for designated videotex data based on set viewing reference point and zoom scale is that the central processor calls the filtering program stored in the memory according to control command information issued by the user.

7. A display adaptive method according to claim 2 or 6,
wherein, said digital filtering process for digital image is a resampling process for digital image.

8. A display adaptive method according to claim 7,
wherein, said resampling process comprises modification of original sampling rate and sample points.

9. A display adaptive method according to claim 2,
wherein, also comprises digital filtering for designated videotex data to restrict bandwidth of generated digital image for meet the requirement of video signal bandwidth of said low-resolution display device.

10. A display adaptive method according to claim 2,
wherein, it further comprises system transformation step for designated image when the system of acquired image data is inconsistent with that of said low-resolution display device.
